(19) United States
(12) Patent Application Publication
(10) Pub. No.: US 2024/0167740 A1
(43) Pub. Date: May 23, 2024

(54) CONTROL METHOD FOR COOLING THE INVERTER OF A CHILLER WITH REFRIGERANT AND THE REFRIGERANT BYPASS PIPELINE THEREOF

(71) Applicant: INDUSTRIAL TECHNOLOY RESEARCH INSTITUTE, Hsinchu (TW)

(72) Inventors: LI-KANG SU, Hsinchu (TW); JENN-CHYI CHUNG, Changhua County (TW); JUN-JIE LIN, Yilan County (TW); KUO-SHU HUNG, Hsichu (TW)

(21) Appl. No.: 18/139,457

(22) Filed: Apr. 26, 2023

(30) Foreign Application Priority Data
Nov. 18, 2022 (TW) 111144099

(51) Int. Cl. F25B 41/20

(52) U.S. Cl. CPC F25B 41/20; F25B 2600/2501; F25B 2600/2513; F25B 2700/191; F25B 2700/195

(57) ABSTRACT

A control method for cooling a refrigerant of an inverter includes the steps of: sucking a portion of the refrigerant out from a reservoir of a condenser in a chiller into a cooling plate of the inverter for cooling; according to a pressure value of the condenser and an outlet pressure value of the inverter, determining a set condition; and, based on the set condition, controlling an opening of an electronic expansion valve to adjust a flow of the portion of the refrigerant in the cooling plate of the inverter. In addition, a refrigerant bypass pipeline of the inverter is also provided.

### CROSS REFERENCE TO RELATED APPLICATION

This application claims the benefits of Taiwan application Serial No. 111144099, filed on Nov. 18, 2022, the disclosures of which are incorporated by references herein in its entirety.

### TECHNICAL FIELD

The present disclosure relates in general to a control method for cooling an inverter of a chiller with a refrigerant and a refrigerant bypass pipeline thereof.

### BACKGROUND

Nowadays, the awareness of energy saving and carbon reduction is gradually rising, and the variable frequency chiller has gradually become the mainstream of the traditional fixed frequency chiller. The reason is that the variable frequency chiller has the characteristics of maintaining a high coefficient of performance (COP) during partial load operation. Nevertheless, an inverter of a compressor of the frequency conversion chiller will generate heat during operation. In case of disappearance of a relevant heat dissipation design, when an internal temperature of the inverter reaches an allowable limit, the inverter will stop operating for self-protection. As a result, the chiller will stop cooling simultaneously. Therefore, designing a stable cooling method for the inverter to operate stably is one of important issues for an inverter chiller (i.e., the variable frequency chiller).

Two major types of cooling methods for the inverter of a compressor of the chiller or a freezer currently used in this industry are an air-cooled type and a water-cooled type. Regarding the air-cooled inverter cooling system, the working principle of the air-cooled inverter cooling system is to use a fan to vacuum the air from the environment to cool a heating electronic component in the inverter. If the ambient temperature is higher, the cooling effect would be poorer. In other words, the cooling performance of the inverter cooling system is easily affected by the ambient temperature. In addition, since the overall body of the system is big, and also power components and fans of the inverter are relative large in sizes, thus the energy consumption is huge. If the heat dissipation thereof is not good, a high temperature thereof would lead the inverter to jump off. Thereof, additional air conditioners are required to reduce the ambient temperature, as which the construction cost would be increased. Further, since a lot of dust might exist in the space where the chiller is located, then, after a long period of use, manual removal of the dust upon the fan blades would be necessary, and comprehensive labor cost would be inevitable. Apparently, operation of the air-cooled inverter cooling system does exist some instinct problems.

On the other hand, regarding the water-cooled inverter cooling system, the inverter is used to be installed in a chiller having internally an ice water and a cooling water. A cooling plate of the inverter can be cooled by vacuuming the ice water or the cooling water. However, while in vacuuming the ice water, the temperature might be dropped down to about 15° C., and from which a condensation phenomenon would occur at a circuit loop of the cooling system (also including the cooling plate). Thereupon, the risk of moisture in the electronic parts inside the inverter or the risk of burning from a possible circuit short would be high. Accordingly, an additional isolated heat exchange system is required to pair the vacuuming operation of the cooling water. The reason is that, if the cooling water enters the cooling plate of the inverter directly, impurities such as dirt may be attached to the tube wall, and fouling in the tube would be expected. After a long-term use, the cooling effect would be reduced. Nevertheless, in the art, the water-cooled inverter cooling system has a hidden worry, which is that, if the pipe wall of the cooling circuit breaks after years of use, leaking of the water at the broken pipe will cause serious harm to the inverter.

Therefore, an issue how to avoid or improve the aforesaid problems happening to the above-mentioned inverter is definitely urgent to be resolved to the skill in the art.

### SUMMARY

Accordingly, it is an object of this disclosure to provide a control method for cooling a refrigerant of an inverter and a refrigerant bypass pipeline of the inverter that can adjust an opening of an electronic expansion valve to control a refrigerant temperature in the refrigerant bypass pipeline so as to maintain an internal temperature of the inverter within an allowable range and simultaneously avoid condensation at the inverter cooling plate. In comparison to the conventional air-cooled or water-cooled inverter cooling system, this disclosure has advantages at least in low maintenance cost and stable operation.

In one embodiment of this disclosure, a control method for cooling a refrigerant of an inverter, utilizing a cooling controller of the refrigerant of the inverter and a refrigerant bypass pipeline of the inverter to perform the control method, the refrigerant bypass pipeline including a bypass pipeline having one end to connect a condenser and another end to connect an evaporator, a middle section of the bypass pipeline being connected with a cooling plate of the inverter, the bypass pipeline being located between the inverter and the evaporator to sequentially connect a pressure sensor and an electronic expansion valve, the control method for cooling the refrigerant of the inverter comprising the steps of: sucking a portion of the refrigerant out from a reservoir of the condenser in the chiller into the cooling plate of the inverter for cooling; according to a pressure value of the condenser and an outlet pressure value of the inverter, determining a set condition; and, based on the set condition, controlling an opening of the electronic expansion valve to adjust a flow of the portion of the refrigerant in the cooling plate of the inverter.

In another embodiment of this disclosure, a refrigerant bypass pipeline of an inverter, comprising a bypass pipeline, one end of the bypass pipeline being connected with a condenser of a chiller while another end thereof is connected with an evaporator of the chiller, a middle section of the bypass pipeline being connected with a cooling plate of an inverter of the chiller; wherein, between the inverter and the evaporator, the bypass pipeline sequentially connects a pressure sensor and an electronic expansion valve, the electronic expansion valve is signally connected with a cooling controller of a refrigerant of the inverter, and the cooling controller evaluates a pressure value and an outlet pressure value of the inverter to determine a set condition for controlling an opening of the electronic expansion valve.

As stated, in the control method for cooling a refrigerant of an inverter and the refrigerant bypass pipeline of the inverter provided by this disclosure, a portion of the refrigerant inside the condenser is used to cool down the cooling plate of the inverter. Namely, circulation of part of the refrigerant in the chiller is utilized to achieve the goal of cooling down the cooling plate of the inverter. In comparison to the prior air-cooled or water-cooled inverter cooling system, the advantages of this disclosure in low maintenance cost and stable operation of the inverter are obvious.

Further, in this disclosure, a small amount of the refrigerant in the reservoir of the condenser is sucked away to enter the cooling plate of the inverter for the cooling operation there. After the cooled refrigerant passes through the electronic expansion valve, the refrigerant would enter the evaporator circulation inside the chiller to reduce the loss of the refrigerant.

In addition, this disclosure utilizes the set condition to control the opening of the electronic expansion valve so as thereby to adjust the flow of the refrigerant inside the cooling plate of the inverter, and thereupon the condensation phenomenon at the cooling plate of the inverter can be avoided.

The present disclosure will become more fully understood from the detailed description given herein below and the accompanying drawings which are given by way of illustration only, and thus are not limitative of the present disclosure.

### BRIEF DESCRIPTION OF THE DRAWINGS

FIG. 1 is a schematic view of an embodiment of a circulatory system of a chiller in accordance with this disclosure;

FIG. 2 is a schematic flowchart of an embodiment of the control method for cooling a refrigerant of an inverter in accordance with this disclosure; and

FIG. 3 is a schematic flowchart of an exemplary example of the control method for cooling a refrigerant of an inverter in accordance with this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

It should be noted that in the description of various embodiments, the so-called “first”, “second” and “third” are used to describe different elements, and these elements are not limited by such predicates. In addition, for the convenience and clarity of description, the thickness or size of each element in the drawings is expressed in an exaggerated, omitted or approximate manner for the understanding and reading of those skilled in the art. The size of each element has no technical significance, is not the actual size, and is also not used to limit the implementation of this disclosure. Any modification of structure, any change of proportional relationship, or any adjustment of size will not affect the content of this disclosure. Possible functions or goals that can be achieved should still fall within the scope covered by the technical content disclosed in this disclosure.

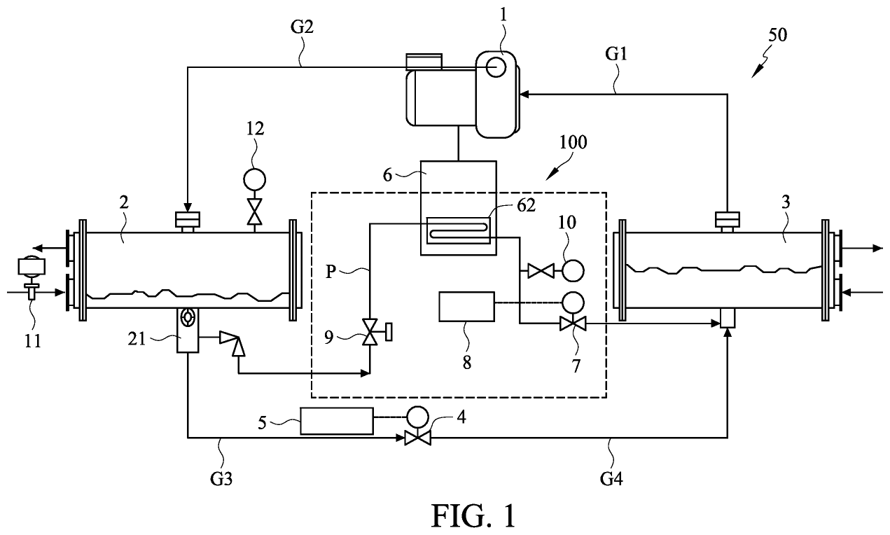

FIG. 1 is a schematic view of an embodiment of a circulatory system of a chiller in accordance with this disclosure. As shown, the chiller includes a compressor 1, a condenser 2, an evaporator 3, an electronic expansion valve 4, a controller 5 and an inverter 6 for driving the compressor 1. By having the controller 5 to control the compressor 1, the condenser 2, the evaporator 3, the electronic expansion valve 4 and the inverter 6, the entire refrigeration cycle 50 can be operated. The theory to operate the refrigeration cycle 50 is to have the inverter 6 to drive the compressor 1. The compressor 1 would suck a low-temperature low-pressure gas-state refrigerant G1 from a top portion of the evaporator 3, and this gas-state refrigerant G1 would be then compressed into a corresponding high-temperature high-pressure gas-state refrigerant G2 to be sent to a top portion of the condenser 2. After entering the condenser 2, the high-temperature high-pressure gas-state refrigerant G2 would heat exchange with cooling water inside copper pipes so as to form a corresponding normal-temperature high-pressure mixed-liquid-and-gas-state refrigerant G3 to enter the electronic expansion valve 4. Due to a rapid pressure drop, the refrigerant G3 passed through the electronic expansion valve 4 would drop the temperature significantly to form a corresponding low-temperature low-pressure liquid-state refrigerant G4 to enter a bottom portion of the evaporator 3. This low-temperature low-pressure liquid-state refrigerant G4 would heat exchange further with water inside copper pipes of the evaporator 3 to form a corresponding ice water for supplying the air-conditioning system.

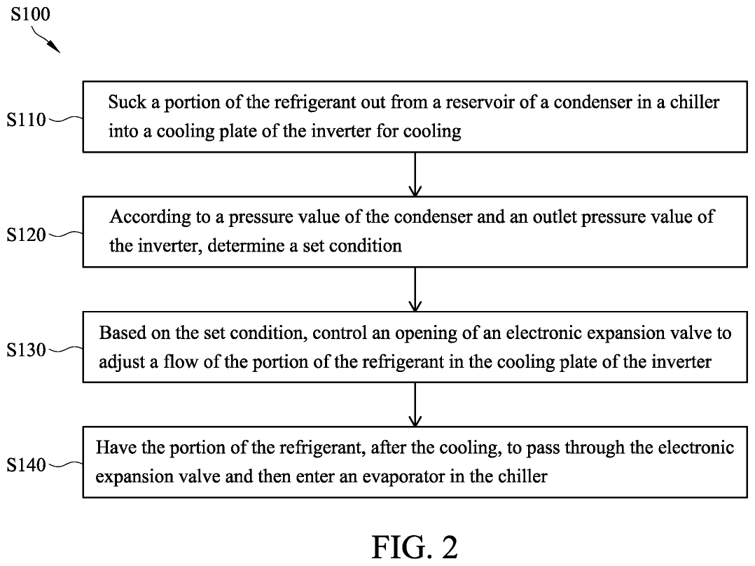

In this disclosure, except that the aforesaid refrigeration cycle 50 can be used to support the air-conditioning system, a refrigerant bypass pipeline 100 of the inverter 6 is also provided. In this embodiment, the refrigerant bypass pipeline 100 can be controlled by the cooling controller 8 of the refrigerant of the inverter 6. This cooling controller 8 and the forgoing controller 5 are different, but can be integrated into a single controller, such as a computer. In particular, after the cooling controller 8 reads programs or instructions stored in a computer for reading, a control method S100 for cooling the refrigerant of the inverter 6, as shown in FIG. 2, can be performed through the refrigerant bypass pipeline 100 of the inverter 6 so as to control part of the refrigerant to flow through the refrigerant bypass pipeline 100 of the inverter 6. The refrigerant bypass pipeline 100 includes a bypass pipeline P having one end to connect the condenser 2, bypass pipeline P and another to connect the evaporator 3. A middle portion of the bypass pipeline P is connected with a cooling plate 62 of the inverter 6. Between the inverter 6 and the evaporator 3, the bypass pipeline P is sequentially connected with a first pressure sensor 10 and an electronic expansion valve 7, in which the electronic expansion valve 7 is signally connected with the cooling controller 8. Operation of the refrigerant bypass pipeline 100 includes: sucking a portion of the refrigerant from a reservoir 21 disposed at the bottom of the condenser 2 of the chiller, while another portion of the refrigerant controlled by the controller 5 is continuously provided to the refrigeration cycle 50 of the air-conditioning system. In particular, a flow of the refrigerant in the refrigerant bypass pipeline 100 is relatively smaller than that in the refrigeration cycle 50 of the chiller for the air-conditioning system, such that the refrigerant for the refrigerant bypass pipeline 100 won't affect the refrigerant for the refrigeration cycle 50 to support the air-conditioning system. In other words, no additional refrigerant is required to the refrigerant bypass pipeline 100. The amount of the refrigerant to be sucked out from the reservoir 21 can be controlled by a control valve 9 mounted at the bypass pipeline P between the condenser 2 and the evaporator 3. Then, the refrigerant is led to the cooling plate 62 inside the inverter 6 to dissipate the heat generated by internal heating electronic components. The refrigerant leaving the cooling plate 62 would flow back to the evaporator 3 of the chiller to complete a circulation.

In this embodiment, an electronic expansion valve (EEXV) 7 would be installed between the cooling plate 62 and the evaporator 3. Installation and functions of this electronic expansion valve 7 are different to those of the forgoing electronic expansion valve 4. The electronic expansion valve 4 disposed between the condenser 2 and the evaporator 3 is used to receive the normal-temperature high-pressure mixed-liquid-and-gas-state refrigerant G3 from the condenser 2, and further the refrigerant G3 is further processed to form a corresponding low-temperature low-pressure liquid-state refrigerant G4 to enter the bottom portion of the evaporator 3. On the other hand, the electronic expansion valve 7 would be signally connected with the cooling controller 8, and the cooling controller 8 can control an opening of the electronic expansion valve 7 through a set condition, such that the cooling plate 62 in the inverter 6 would hit a condensation phenomenon. Further, the temperature of the cooling plate 62 in the inverter 6 can be adjusted to protect electronic components inside the inverter 6 so as to continue a stable operation.

Under such an arrangement, the shortcoming in the art that the inverter of the conventional chiller adopting an air-cooling system would meet poor heat dissipation while the temperature of the ambient environment is too high, can be well resolved, without additional installment of air conditioner or a heat dissipation fan. Thereupon, the accompanying construction and labor cost can be substantially reduced. In addition, in the situation that the inverter of the chiller adopts the water-cooling system, while a cooling water of the suction device is applied to dissipate the heat, an isolation system is required to avoid possible fouling in the pipe. As such, the corresponding increase in the production cost would be inevitable. On the other hand, if the ice water of the suction device is applied to perform the heat dissipation, a problem of water condensation would be met to cause the risk of burning electronic components and circuits of the inverter. Nevertheless, no matter whether the ice water or the cooling water is used, a water leakage caused by a breaking pipe would propagate to harm the inverter. In this disclosure, a portion of the refrigerant in the refrigeration cycle 50 is adopted to perform heat dissipation. This refrigerant is non-toxic, non-corrosive, non-electric conductive and less in flow rate, and, while in meeting a leak, the risk upon the inverter 6 would be reduced. In comparison to the aforesaid water-cooling system, the problem caused by sucking the ice water or the cooling water would be resolved by the design provided in this disclosure. This disclosure introduces the cooling controller 8 to adjust the opening of the electronic expansion valve 7 according to the set condition, such that the condensation phenomenon at the cooling plate 62 inside the inverter 6 can be avoided so as to provide well protection to the electronic components inside the inverter 6. In the following description, FIG. 2 is utilized to elucidate the control method 8100 for cooling a refrigerant of an inverter applied to the chiller in accordance with this disclosure.

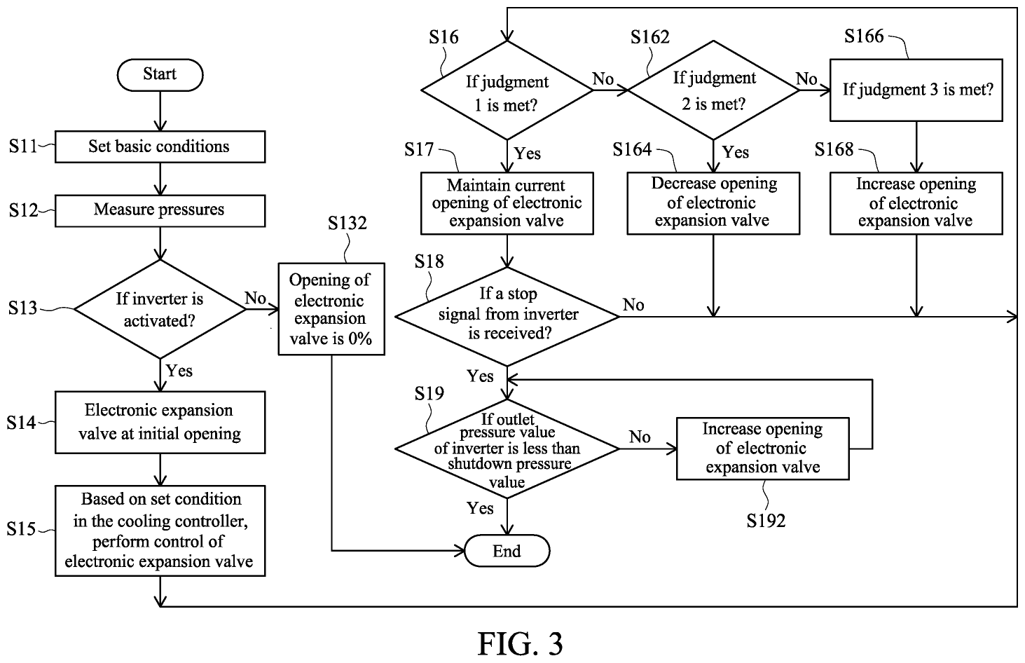

FIG. 2 is a schematic flowchart of an embodiment of the control method for cooling a refrigerant of an inverter in accordance with this disclosure. FIG. 3 is a schematic flowchart of an exemplary example of the control method for cooling a refrigerant of an inverter in accordance with this disclosure. As shown in FIG. 1 to FIG. 3, after the cooling controller 8 read the stored programs or instructions, the refrigerant bypass pipeline 100 of the inverter 6 in FIG. 1 is utilized to execute each step of the control method S100 for cooling a refrigerant of the inverter 6 of the chiller of FIG. 2. The control method S100 for cooling the refrigerant of the inverter 6 includes Step S110 to Step S140 as follows.

In Step S110, a portion of the refrigerant inside the reservoir 21 of the condenser 2 in the chiller is sucked and provided to the cooling plate 62 of the inverter 6 for performing cooling there, via the bypass pipeline P. A flow of this portion of the refrigerant is relatively less than a required flow of the refrigerant in the refrigeration cycle 50 of the chiller for the air-conditioning system.

Prior to Step S110, Step S11 of FIG. 3 can be performed in advance to set basic conditions. The setting may include at least the following set values: an initial opening of the electronic expansion valve 7, an opening percentage for each action of the electronic expansion valve 7, a delay for returning to zero opening of the electronic expansion valve 7 while in meeting a shutdown, a shutdown pressure of a target inverter 6 while in a shutdown, a time interval for every action of the electronic expansion valve 7, a dead band controlled by the electronic expansion valve 7 and a target set value (S.V.), in which the target set value is only applicable to the following first set condition.

In one embodiment, when the inverter 6 starts, the electronic expansion valve 7 would open to an initial opening value ranged within 50%˜100%. Such an opening can prevent the refrigerant to jam the pipe. The target set value (S.V.) is set according to instant practical requirements. While the inverter 6 is running, the electronic expansion valve 7 would evaluate the target set value to change the opening of the electronic expansion valve 7, and the opening corresponding to each move of the electronic expansion valve 7 can be within 1%˜10%. In particular, the time interval for every action of the electronic expansion valve 7 can be set to range within 1˜10 sec. When the inverter 6 is shutdown, a set value of the delay for returning to zero opening of the electronic expansion valve 7 would be within 1˜10 sec. That is, after the delay, the opening of the electronic expansion valve 7 is 0% (i.e., closed). In addition, while in a shutdown, an outlet pressure value (PTR) of the target inverter 6 is determined according to practical requirements. For example, if the PTR is greater than the shutdown pressure value, then the electronic expansion valve 7 would begin to discharge, and the electronic expansion valve 7 would be closed again till the PTR is less than the shutdown pressure value. In addition, the controlled dead band of the electronic expansion valve 7 is generally set to be within 20˜50 kPa. In this embodiment, all the aforesaid settings are set and then stored in the cooling controller 8 of the refrigerant of the target inverter 6.

Then, in performing Step S120, according to a pressure value (PTC) of the condenser 2 and the outlet pressure value (PTR) of the target inverter 6, a set condition can be determined.

Practically, Step S120 includes Step S12 shown in FIG. 3 to perform pressure measurement. Referring back to FIG. 1, this embodiment includes three sensors; i.e., a first pressure sensor 10, a temperature sensor 11 and a second pressure sensor 12. The first pressure sensor 10, disposed between the inverter 6 and the electronic expansion valve 7, is to measure the outlet pressure value (PTR) between the inverter 6 and the electronic expansion valve 7. The temperature sensor 11, disposed at an inlet of the condenser 2, is to measure a cooling-water inlet temperature (CWT) of the condenser 2. The second pressure sensor 12, disposed at the condenser 2, is to measure the condensation pressure value inside the condenser 2. The outlet pressure value (PTR) measured by the first pressure sensor 10, the cooling-water inlet temperature (CWT) of the condenser 2 measured by the temperature sensor 11, and the condensation pressure value inside the condenser 2 measured by the second pressure sensor 12 are individually transmitted to the cooling controller 8 of the refrigerant of the inverter 6; in which the cooling controller 8 would convert the cooling-water inlet temperature (CWT) of the condenser 2 into a corresponding refrigerant pressure value as the pressure value (PTC) inside the condenser 2. Or, the cooling controller 8 would define the condensation pressure value inside the condenser 2 measured by the second pressure sensor 12 as the pressure value (PTC) inside the condenser 2.

Then, Step S120 includes Step S13 to Step S15 of FIG. 3. Step S13 is to determine whether or not the inverter 6 is activated. In one embodiment, through the knowledge of communication between the inverter 6 and the cooling controller 8, it can be determined if the inverter 6 is activated. If the inverter 6 is not activated, then go to perform Step S132, and further to end the method. At this time, the opening of the electronic expansion valve 7 is 0%. If the inverter 6 is running, then go to the next step. In Step S14, the electronic expansion valve 7 is opened to the initial opening value. Then, in Step S15, according to the set condition in the cooling controller 8, the electronic expansion valve 7 is controlled. In one embodiment, the cooling controller 8 would control the opening of the electronic expansion valve 7. With the initial opening value set in Step S11 and the set condition written by the cooling controller 8, the electronic expansion valve 7 is activated accordingly. The set condition can be determined according to the pressure value (PTC) of the condenser 2 and the outlet pressure value (PTR) of the inverter 6, and the goal is to control a process value within the set value (S.V.), such that the inverter 6 can be maintained to prevent the entire chiller from condensation. In the following description, two different types of the set conditions are taken as exemplary examples of this embodiment, but not limited thereto.

In the first type of the set conditions, after the cooling-water inlet temperature (CWT) of the condenser 2 is converted to the corresponding refrigerant pressure value as the pressure value (PTC) inside the condenser 2, a difference between the refrigerant pressure value and the outlet pressure value (PTR) between the inverter 6 and the electronic expansion valve 7 is set to be a process value (P.V.). In detail, the cooling-water inlet temperature (CWT) of the condenser 2 measured by the temperature sensor 11 can be converted into a corresponding refrigerant pressure value through appropriate empirical algorithms, and the refrigerant pressure value would be defined as the pressure value (PTC) of the condenser 2. The condensation pressure value can be obtained by converting the cooling-water inlet temperature (CWT) into a corresponding refrigerant saturation pressure, physically which is similar to the dew point temperature. Thus, the first type of the set conditions is to utilize the control upon the difference between the condensation pressure value and the outlet pressure value (PTR) to control the outlet pressure value (PTR) less than the dew point temperature, such that the inverter 6 and the associated components can be protested from pipe condensation. In addition, the set value (S.V.) is a self-defined value set in Step S11, and, according to instant practical needs, the set value (S.V.) is set to be a dead band (DB). All the aforesaid settings are performed in the cooling controller 8.

In the second type of the set conditions, the definition of the process value (P.V.) is the outlet pressure value (PTR) between the inverter 6 and the electronic expansion valve 7. The set value (S.V.) is a condensation pressure value inside the condenser 2 measured by the second pressure sensor 12. According to practical needs, a dead band is set for the set value (S.V.). Since the refrigerant temperature converted from the condensation pressure value of the condenser 2 is definitely higher than the ambient temperature, thus the outlet pressure value (PTR) between the inverter 6 and the electronic expansion valve 7 can be controlled to be similar to the condensation pressure value of the condenser 2 by controlling the opening of the electronic expansion valve 7. If the outlet pressure value (PTR) is far less than the condensation pressure value, then it is implied that the temperature of the inverter 6 is too low. In order to avoid condensation, the opening of the electronic expansion valve 7 must be reduced to decrease the cooling capacity. If the outlet pressure value (PTR) is far greater than the condensation pressure value, then it is implied that the temperature of the inverter 6 is too high. In order not to avoid the increase at the opening of the electronic expansion valve 7 caused by over heating, the cooling capacity would be increased to avoid possible pipe condensation at the inverter 6 and the associated components. All the aforesaid settings are performed in the cooling controller 8.

Then, in Step S130, the set condition is utilized to control the opening of the electronic expansion valve 7 so as to adjust the flow of the portion of the refrigerant in the cooling plate 62 of the inverter 6. Namely, by controlling the opening of the electronic expansion valve 7, the heat-dissipation capacity can be adjusted to prevent the cooling plate 62 of the inverter 6 from condensation.

Practically, Step S130 includes Step S16 to Step S19 of FIG. 3. In Step S16, it is determined whether or not a judgment 1 is met. In this embodiment, judgment 1 is to determine if or not the P.V. is between a first variable and a second variable, in which the first variable is (S.V.+DB), the second variable is (S.V.−DB), and DB is the dead band.

In the first type of the set conditions, the P.V. is the difference between the refrigerant pressure value converted from the cooling-water inlet temperature (CWT) of the condenser 2 and the outlet pressure value (PTR) between the inverter 6 and the electronic expansion valve 7, and the S.V. is a self-defined set value set in Step S11.

In the second type of the set conditions, the P.V. is the outlet pressure value (PTR) between the inverter 6 and the electronic expansion valve 7, and the S.V. is the condensation pressure value inside the condenser 2 measured by the second pressure sensor 12. In other words, in the second type of the set conditions, no additional setting of basic conditions is required in the aforesaid Step S11.

In the determination of Step S16, if the judgment 1 is not satisfied (i.e., the P.V. is not between (S.V.+DB) and (S.V.−DB)), then go to perform Step S162. In this embodiment, the judgment 2 is P.V.≥(S.V.+DB) for the first type of the set conditions, and P.V.≤(S.V.−DB) for the second type of the set conditions. If the judgment 2 is not satisfied, then go to perform Step S164. In this embodiment, the judgment 3 is P.V.≤(S.V.−DB) for the first type of the set conditions, and P.V.≥(S.V.+DB) for the second type of the set conditions. If the judgment 3 is satisfied, then increase the opening of the electronic expansion valve 7 (Step S168). If, in the aforesaid Step S162, the judgment 2 is satisfied, then decrease the opening of the electronic expansion valve 7 (Step S164). In this embodiment, increments for increasing or decreasing the opening of the electronic expansion valve 7 are set in the aforesaid Step S11. For example, if 1%˜10% is the acceptable range for the electronic expansion valve 7 to change the opening at each action, then the interval for each move of the electronic expansion valve 7 can be set to range within 1˜10 sec. In addition, in the aforesaid Step S164, after performing Step 168, then the process would go back to Step S16 for determining whether or not the P.V. is located between (S.V.+DB) and (S.V.−DB).

In the aforesaid Step S16, if it is determined that the judgment 1 is met (I.e., P.V. is between (S.V.+DB) and (S.V.−DB)), then go to Step S17 to maintain the existing opening of the electronic expansion valve 7.

Then, in Step S18, it is determined whether or not a stop signal of the inverter 6 has been received. If negative, then go back to Step 16. If positive, then go to the next step to perform Step S19. In Step 19, it is determined whether or not the outlet pressure value (PTR) of the inverter 6 is less than the shutdown pressure value, in which the shutdown pressure value is set in Step S11. If the determination of Step S19 is negative, then go to Step S192 to increase the opening of the electronic expansion valve 7, and go back to Step S19 to perform again the determination. Otherwise, if the determination of Step S19 is positive (i.e., the outlet pressure value (PTR) of the inverter 6 is less than the shutdown pressure value), then begin time counting (i.e., for the delay for returning to zero opening of the electronic expansion valve 7 set in Step S11, 1˜10 sec for example). After a period of time, the opening of the electronic expansion valve 7 would turn zero, and the process regarding the refrigerant bypass pipeline 100 of the inverter 6 as shown in FIG. 1 is ended.

Referring back to FIG. 2 and FIG. 1, after Step S130 is performed, then go to Step S140. In Step S140, after the portion of the refrigerant is cooled down and then passes through the electronic expansion valve 7 to join an internal circulation inside an evaporator 3 of the chiller. Thereupon, no additional refrigerant is required for the refrigerant bypass pipeline 100 of the inverter 6 to heat dissipate heating electronic components inside the cooling plate 62 of the inverter 6. In addition, the refrigeration cycle 50 of the air-conditioning system can be maintained. Further, the set condition can be introduced to adjust the opening of the electronic expansion valve 7, such that the condensation phenomenon of the cooling plate 62 in the inverter 6 can be further avoided to further ensure and protect the electronic components inside the inverter 6.

In summary, in the control method for cooling a refrigerant of an inverter and the refrigerant bypass pipeline of the inverter provided by this disclosure, a portion of the refrigerant inside the condenser is used to cool down the cooling plate of the inverter. Namely, circulation of part of the refrigerant in the chiller is utilized to achieve the goal of cooling down the cooling plate of the inverter. In comparison to the prior air-cooled or water-cooled inverter cooling system, the advantages of this disclosure in low maintenance cost and stable operation of the inverter are obvious.

Further, in this disclosure, a small amount of the refrigerant in the reservoir of the condenser is sucked away to enter the cooling plate of the inverter for the cooling operation there. After the cooled refrigerant passes through the electronic expansion valve, the refrigerant would enter the evaporator circulation inside the chiller to reduce the loss of the refrigerant.

In addition, this disclosure utilizes the set condition to control the opening of the electronic expansion valve so as thereby to adjust the flow of the refrigerant inside the cooling plate of the inverter, and thereupon the condensation phenomenon at the cooling plate of the inverter can be avoided.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A control method for cooling a refrigerant of an inverter, utilizing a cooling controller of the refrigerant of the inverter and a refrigerant bypass pipeline of the inverter to perform the control method, the refrigerant bypass pipeline including a bypass pipeline having one end to connect a condenser and another end to connect an evaporator, a middle section of the bypass pipeline being connected with a cooling plate of the inverter, the bypass pipeline being located between the inverter and the evaporator to sequentially connect a pressure sensor and an electronic expansion valve, the control method for cooling the refrigerant of the inverter comprising the steps of:
sucking a portion of the refrigerant out from a reservoir of the condenser in the chiller into the cooling plate of the inverter for cooling;
according to a pressure value of the condenser and an outlet pressure value of the inverter, determining a set condition; and
based on the set condition, controlling an opening of the electronic expansion valve to adjust a flow of the portion of the refrigerant in the cooling plate of the inverter.

2. The control method for cooling a refrigerant of an inverter of claim 1, wherein the step of determining the set condition includes the steps of:
measuring a cooling-water inlet temperature of the condenser;
deriving the pressure value of the condenser by converting the cooling-water inlet temperature of the condenser to a corresponding refrigerant pressure value as the pressure value;
defining a difference between the refrigerant pressure value and the outlet pressure value between the inverter and the electronic expansion valve as a process value; and
setting a set value.

3. The control method for cooling a refrigerant of an inverter of claim 2, wherein the step of controlling the opening of the electronic expansion valve includes the steps of:
determining whether or not the process value is between a first variable and a second variable, wherein the first variable is a sum of the preset value and a dead band, and the second variable is a difference of the preset value and the dead band;
if positive, maintaining the opening of the electronic expansion valve;
if negative, determining whether or not the process value is greater than or equal to the first variable;
upon when the process value is greater than or equal to the first variable, decreasing the opening of the electronic expansion valve; and
upon when the process value is less than the first variable, increasing the opening of the electronic expansion valve.

4. The control method for cooling a refrigerant of an inverter of claim 1, wherein the step of determining the set condition includes the steps of:
setting the outlet pressure value between the inverter and the electronic expansion valve as a process value; and
setting a condensation pressure value in the condenser as a set value.

5. The control method for cooling a refrigerant of an inverter of claim 4, further including steps of:
determining whether or not the process value is between a first variable and a second variable, wherein the first variable is a sum of the preset value and a dead band, and the second variable is a difference of the preset value and the dead band;
if positive, maintaining the opening of the electronic expansion valve;
if negative, determining whether or not the process value is greater than or equal to the first variable;
upon when the process value is greater than or equal to the first variable, decreasing the opening of the electronic expansion valve; and
upon when the process value is less than the first variable, increasing the opening of the electronic expansion valve.

6. The control method for cooling a refrigerant of an inverter of claim 1, wherein the step of sucking a portion of the refrigerant out from a reservoir of the condenser in the chiller includes a step of:
having a flow of the portion of the refrigerant to be relatively less than another flow of the refrigerant of a refrigeration cycle for the chiller.

7. The control method for cooling a refrigerant of an inverter of claim 1, wherein the step of controlling the opening of the electronic expansion valve to adjust the flow of the portion of the refrigerant in the cooling plate of the inverter includes a step of:
having the portion of the refrigerant, after the cooling, to pass through the electronic expansion valve and then enter the evaporator in the chiller.

8. A refrigerant bypass pipeline of an inverter, comprising a bypass pipeline, one end of the bypass pipeline being connected with a condenser of a chiller while another end thereof is connected with an evaporator of the chiller, a middle section of the bypass pipeline being connected with a cooling plate of an inverter of the chiller; wherein, between the inverter and the evaporator, the bypass pipeline sequentially connects a pressure sensor and an electronic expansion valve, the electronic expansion valve is signally connected with a cooling controller of a refrigerant of the inverter, and the cooling controller evaluates a pressure value and an outlet pressure value of the inverter to determine a set condition for controlling an opening of the electronic expansion valve.

9. The refrigerant bypass pipeline of an inverter of claim 8, further including a control valve disposed at the bypass pipeline between the condenser and the evaporator.
